(19) United States
(12) Patent Application Publication
(10) Pub. No.: US 2024/0168948 A1
(43) Pub. Date: May 23, 2024

(54) LEARNED WORKLOAD SYNTHESIS

(71) Applicant: Microsoft Technology Licensing, LLC, Redmond, WA (US)

(72) Inventors: Yiwen ZHU, San Francisco, CA (US); Joyce CAHOON, Woodinville, WA (US); Subramaniam Venkatraman KRISHNAN, Santa Clara, CA (US); Chengcheng WAN, Chicago, IL (US)

(21) Appl. No.: 18/058,359

(22) Filed: Nov. 23, 2022

(51) Int. Cl. G06F 16/2453; G06F 11/34; G06F 16/21

(52) U.S. Cl. CPC G06F 16/2453; G06F 11/3457; G06F 16/21

(57) ABSTRACT

Learned workload synthesis is disclosed. In an aspect of the present disclosure, a time series dataset corresponding to a target workload is received. A set of performance characteristics is determined from the time series dataset. A call is provided to a prediction model to determine a candidate query sequence based on the determined set of performance characteristics. A synthetic workload is generated based on the determined candidate query sequence. A synthetic workload is generated based on the determined candidate query sequence. A first similarity between a first performance profile of the synthetic workload and a second performance profile of the target workload meets a workload performance threshold condition. A performance insight is determined based on the synthetic workload. In a further aspect, the prediction model is trained to predict performance profiles based on workload profiles generated by executing benchmark queries using hardware and/or software configurations.

### BACKGROUND

Database benchmarking and workload replay are used to drive system design, evaluate workload performance, determine product evolution, and guide cloud migration. However, compliance with privacy protection regulations, such as General Data Protection Regulation (GDPR), limits access to user-specific data, such as specific queries executed in a workload and user-identifying data the queries are executed against.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein provide for learned workload synthesis. In an aspect of the present disclosure, a time series dataset corresponding to a target workload is received. A set of performance characteristics is determined from the time series dataset. A call is provided to a prediction model to determine a candidate query sequence based on the determined set of performance characteristics. A synthetic workload is generated based on the determined candidate query sequence, with a first similarity between a first performance profile of the synthetic workload and a second performance profile of the target workload meeting a workload performance threshold condition. A performance insight is determined based on the synthetic workload.

In a further aspect of the present disclosure, the prediction model is a trained prediction model. A plurality of benchmark queries and a plurality of hardware (and/or software) configurations are received. A plurality of workload profiles is generated by executing benchmark queries of the received benchmark queries using respective hardware (and/or software) configurations of the received hardware (and/or software) configurations. The prediction model is trained to predict performance profiles based on the generated workload profiles.

In a further aspect of the present disclosure, a set of time frames is generated in the time series dataset. Each time frame of the set of time frames corresponds to a respective range of the time series dataset. Performance characteristics are determined for each time frame in the set of time frames. A respective call for a time frame in the set of time frames is provided to the prediction model, the respective call including performance characteristics determined for the time frame.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for learned synthesis of workloads in accordance with an example embodiment.

FIG. 2 shows a flowchart of a process for training a prediction model to determine performance profiles in accordance with an example embodiment.

FIG. 3 shows a block diagram of a system for training a prediction model in accordance with an example embodiment.

FIG. 4 shows a flowchart of a process for learned synthesis of workloads in accordance with an example embodiment.

FIG. 5 shows a block diagram of the workload synthesizing system of FIG. 1, according to an example embodiment.

FIG. 6 shows a block diagram of the workload synthesizing system of FIG. 1, according to an example embodiment.

FIG. 7A shows a flowchart of a process for learned synthesis of workloads in accordance with an example embodiment.

FIG. 7B shows a flowchart of a process for providing a call to a prediction model to determine a candidate query sequence in accordance with an example embodiment.

FIG. 7C shows a flowchart of a process for generating a synthetic workload in accordance with an example embodiment.

FIG. 8 shows a flowchart of a process for providing a call to a prediction model in accordance with an example embodiment.

FIG. 9 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

As set forth in the Background section, database benchmarking and workload replay have been widely used to drive system design, evaluate workload performance, determine product evolution, and guide cloud migration. Database benchmarking is used to measure and compare the performance of database systems. Workload replay enables the reproduction of performance inefficiencies in a particular workload, e.g., for diagnosing the root cause of performance bugs or confirming the effectiveness of a fix or re-configuration. Database benchmarking and workload replay processes provide insight into performance characteristics, which allows developers to determine improvements in database engines (e.g., in query processing, query optimization, improvements in storage layers) and allows end-users, database administrators, and/or cloud service providers to tune configurations of a database.

However, database benchmarking and workload replay processes are presented with several challenges. For instance, as the number of database-backed applications increases, the workloads executed against a database evolves, resulting in workloads with wide ranges of schema and query types covering a diverse array of services and application scenarios. Such variety in workloads increases the complexity in benchmarking a database, as a single standardized benchmark may not represent the variety of workloads and cover the spectrum of analytic needs.

Furthermore, workload replay traditionally records queries and user data of users that execute workloads in order to replay the specific set of queries executed by a computing device associated with the user. Accessing customer data and queries introduces privacy, security, and scalability concerns. For instance, privacy regulations exist, such as the General Data Protection Regulation (GDPR). The GDPR is a regulation in European Union (EU) law on data protection and privacy in the EU and the European Economic Area (EEA). The regulation contains provisions and requirements related to the processing of personal data of individuals (formally called “data subjects” in the GDPR) who are located in the EEA, and applies to any enterprise—regardless of its location and the data subjects' citizenship or residence—that is processing the personal information of individuals inside the EEA. Compliance with GDPR restricts access and/or use of user data. Moreover, replaying customer-specific workloads requires using the same or similar hardware and software configurations as the original workload.

Embodiments described herein enable synthesis of workloads in a manner intended to address one or more of the above challenges. For example, embodiments described herein leverage a prediction model to determine candidate queries for generating a synthetic workload. In accordance with one or more embodiments, the prediction model is a trained model that predicts performance characteristics of a workload based on the workload and hardware configurations (e.g., type of processor, number of computer cores, graphics card, available memory, etc.) and/or software configurations (e.g., database configurations (e.g., database type, database engine version, buffer pool size, blocked process threshold, etc.), application settings, and/or the like). The prediction model is trained using workload profiles generated from benchmark data and configuration data. A workload profile is a “footprint” representative of a performance profile for an execution of a workload using a particular hardware and/or software configuration. The performance profile includes various performance characteristics indicative of the performance of a computing device that was used to execute the workload. Examples of performance characteristics include, but are not limited to, how much memory was used, a percentage of computer processing unit (CPU) cores used, a number of CPU cores used, the number of input/output operations per second (IOPS), latency over time (e.g., end-to-end latency of an IO operation), the time to execute the workload, and/or any other data that indicates the performance of a computing device used to execute a particular workload. In accordance with an embodiment, the performance profile also includes additional data associated with the execution of a workload (e.g., query characteristics).

Benchmark data includes benchmark queries and sample database data for executing the benchmark queries. In accordance with an embodiment, benchmark data includes benchmark queries and/or benchmark datasets for different database sizes, scaling factors, data schema, and/or query schema.

The configuration data includes various hardware and/or software configurations that can be used to execute workloads. Hardware configurations include, but are not limited to, the type of computing device (or system of computing devices) used to execute workloads, processor types, number of compute cores, graphics cards, available memory, and/or any other information regarding the hardware used to execute workloads. Software configurations include, but are not limited to, database configurations (e.g., database type, database engine version, buffer pool size, blocked process threshold, and/or the like), application settings, cloud and/or any other settings/configurations of databases, supporting applications, or other software used to execute workloads.

As discussed further herein, workload profiles are generated by executing one or more benchmark queries using various hardware and/or software configurations. For example, in an embodiment, benchmark queries are grouped into benchmark workloads that are executed using various hardware and/or software configurations for generating the workload profiles.

Techniques described herein generate synthetic workloads using a prediction model. For example, a time series dataset corresponding to a target workload is received. The time series dataset includes performance data and configuration data for the target workload. In this context, a “target workload” is a workload that was previously executed by a computing device associated with a user (e.g., a customer user, an enterprise user, a developer user, an administrative user, etc.) or a previously generated synthetic workload. A set of performance characteristics are determined from the time series dataset. The prediction model is called to determine a candidate query based on the determined set of performance characteristics. In accordance with an embodiment, multiple candidate query sequences are determined. For example, as discussed further herein, the prediction model in accordance with one or more embodiments generates a sequence of candidate queries (e.g., a “candidate query sequence”). A synthetic workload is generated based on the determined candidate query (or queries). The synthetic workload has a performance profile that is similar to a performance profile of the target workload. A performance insight may be determined based on the generated synthetic workload.

As such, methods, systems, and computer program products are provided for workload synthesis. Embodiments described herein may generate a synthetic workload without requiring access to user identifying data. In other words, techniques described herein generate a synthetic workload with a performance profile similar to the performance profile of a workload previously executed by a computing device of a user using anonymous data corresponding to the previously executed workload (e.g., the “target workload”).

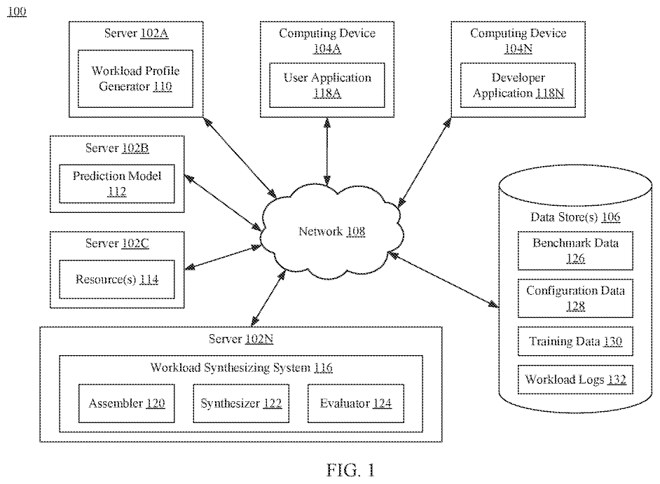

Such embodiments may be configured in various ways in various environments. For instance, FIG. 1 shows a block diagram of a system 100 (“system 100” hereinafter) for learned synthesis of workloads in accordance with an example embodiment. As shown in FIG. 1, system 100 includes servers 102A-102N, computing devices 104A-104N, and one or more data store(s) 106 (“data store 106” hereinafter). Server 102A includes a workload profile generator 110, server 102B includes a prediction model 112, server 102C includes one or more resources 114 (“resources 114” hereinafter), and server 102N includes a workload synthesizing system 116. Workload synthesizing system 116 includes an assembler 120, a synthesizer 122, and an evaluator 124. In embodiments, servers 102A-102N, computing devices 104A-104N, and data store 106 are communicatively coupled via one or more networks 108 (“network 108” hereinafter), comprising one or more of local area networks (LANs), wide area networks (WANs), enterprise networks, the Internet, etc., and including one or more of wired and/or wireless portions.

Resources 114 include resources of a database system, as well as any other resources accessible by computing devices over network 108. Examples of resources 114 include, but are not limited to, physical devices (e.g., computing devices, servers, or network devices), components of physical devices (e.g., processors, memories, storage interfaces), virtual machines, applications (e.g., cloud applications, database applications, web applications, and/or the like), data stores (e.g., databases, blob storage, and/or the like), information objects (e.g., a document, Web page, image, audio file, video file, output of an executable), and/or the like.

Data store 106 maintains data accessible to one or more components of system 100. Examples of data store 106 include, but are not limited to, a database, a file repository, and/or any other type of storage suitable for storing data described herein. Examples of data maintained by data store 106 include, but are not limited to, data files (e.g., documents), database objects (e.g., tables, directories, etc.), structured data, unstructured data, semi-structured data, data containers, logs, etc. As shown in FIG. 1, data store 106 stores workload logs benchmark data 122, hardware data 124, and training data 126, as discussed further below.

Computing devices 104A-104N include the computing devices of users (e.g., individual users, family users, enterprise users, governmental users, developers, service team users, etc.) that may access network-accessible resources such as servers 102A-102N over network 108. System 100 may include fewer or more computing devices than depicted in FIG. 1. Computing devices 104A-104N may each be any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. Each of computing devices 104A-104N store data and execute computer programs, applications, and/or services. For example, computing device 104A as shown in FIG. 1 includes a user application 118A that enables a user to execute a workload (e.g., including one or more queries) against a database. A user of computing device 104A may enter input via user application 118A or otherwise interact with the application to execute the workload. As also shown in FIG. 1, computing device 104N includes a developer application 118N that enables a user to perform developer operations (e.g., database benchmarking or workload replay) with respect to the database and/or workload logs 132.

Servers 102A-102N and any additional resources define a network accessible server infrastructure. In example embodiments, servers 102A-102N form a network-accessible server set, such as a cloud computing server network. For example, servers 102A-102N in accordance with an embodiment comprise a group or collection of servers (e.g., computing devices) that are each accessible by a network such as the Internet (e.g., in a “cloud-based” embodiment) to store, manage, and process data. System 100 may include any number of servers, fewer or greater than the number of servers 102A-102N shown in FIG. 1. Each of servers 102A-102N are configured to execute one or more services (including microservices), applications, and/or supporting services. A “supporting service” is a cloud computing service/application that manages a set of servers (e.g., a cluster of servers) to operate as network-accessible (e.g., cloud-based) computing resources for users. Examples of supporting services. Examples of supporting services include Microsoft® Azure®, Amazon Web Services™, Google Cloud Platform™, IBM® Smart Cloud, etc. A supporting service may be configured to build, deploy, and manage applications and services on the corresponding set of servers. Each instance of the supporting service may implement and/or manage a set of focused and distinct features or functions on the corresponding server set, including virtual machines, operating systems, application services, storage services, database services, messaging services, etc. Supporting services may be coded in any programming language. Each of servers 102A-102N may be configured to execute any number of services and/or other resources. For example, workload profile generator 110, prediction model 112, resources 114, and workload synthesizing system 116 in accordance with an embodiment are implemented as services executed by respective servers 102A-102N. Furthermore, in accordance with another embodiment, workload synthesizing system 116 is implemented by multiple servers other than (or including) server 102N.

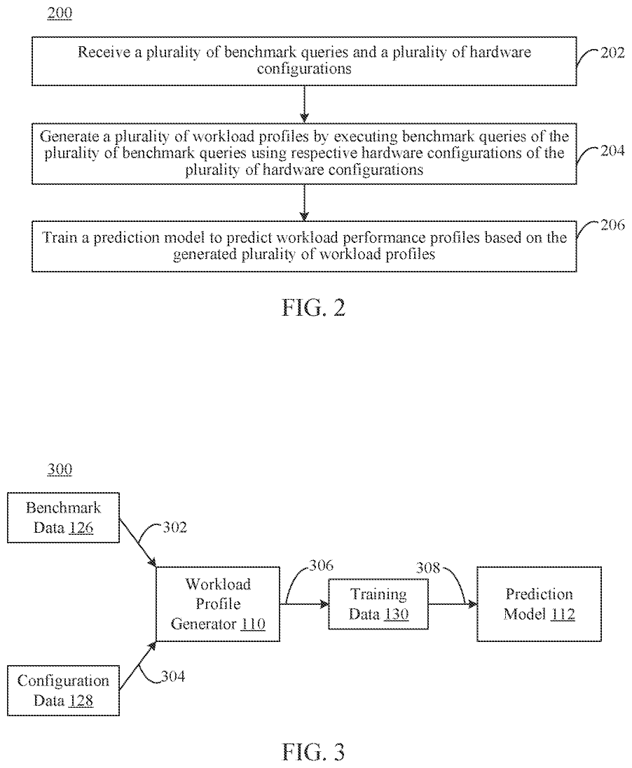

Workload profile generator 110 generates workload profiles for use in training prediction model 112. For example, in accordance with an embodiment, workload profile generator 110 generates workload profiles by executing benchmark queries using respective hardware configurations. For instance, workload profile generator 110 may access benchmark data 126 and hardware data 128 stored in data store 106 for obtaining respective benchmark queries and respective hardware configurations. Workload profile generator 110 may select hardware of resources 114, server 102A, and/or other components of system 100 for executing the respective benchmark queries based on a respective hardware configuration. Additional details regarding the generation of workload profiles will be discussed further below with respect to FIGS. 2 and 3.

Prediction Model 112 predicts performance profiles based on workload profiles. For example, prediction model 112 in accordance with an embodiment is a machine learning model trained using workload profiles generated by workload profile generator 110. Additional details regarding the training of prediction model 112 will be discussed further below with respect to FIGS. 2 and 3. In accordance with an embodiment, prediction model 112 includes multiple prediction models (e.g., separate prediction models trained to predict workload profiles for workloads executed on different subsets of hardware and/or software configurations, separate prediction models trained to predict workload profiles for different types of workloads, and/or the like).

Workload synthesizing system 116 generates, given a performance profile, a synthetic workload with a similar performance profile to a previously executed performance profile. As shown in FIG. 1, workload synthesizing system 116 includes assembler 120, synthesizer 122, and evaluator 124. Assembler 120 determines performance characteristics from a time series dataset corresponding to a target workload. For instance, assembler 120 may generate the performance characteristics from the time series dataset and corresponding hardware and/or software configuration of the computing device the user used for executing the workload (e.g., computing device 104A). The time series dataset and configuration data of the computing device are stored in workload logs 132. Assembler 120 also generates a synthetic workload from candidate queries received by synthesizer 122. Additional details regarding the determination of performance characteristics and generation of synthetic workloads will be discussed further below with respect to FIGS. 4-7A and 7C.

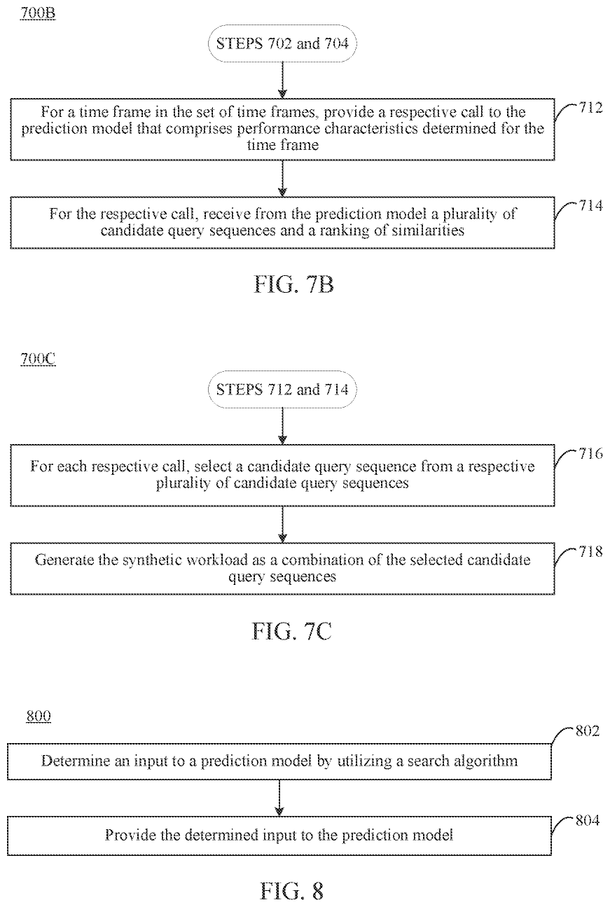

Synthesizer 122 calls prediction model 112 to determine candidate queries. For example, synthesizer 122 receives performance characteristics determined by assembler 120 and provides a call to prediction model 112 to determine a candidate query based on the performance characteristics. In accordance with an embodiment, synthesizer 122 provides a call to prediction model 112 to determine a candidate query sequence based on the performance characteristics. A candidate query sequence includes one or more queries (e.g., benchmark queries from benchmark data 126, as described elsewhere herein). The candidate query sequence may also include an order in which the one or more queries are executed, a database to execute the queries against (e.g., a benchmark database, as described elsewhere herein), settings of the database engine that executes the one or more queries, hardware and/or software configurations used to execute the queries, and/or any other additional information prediction model 112 determines based on the call provided by synthesizer 122. In accordance with an embodiment, synthesizer 122 utilizes a search algorithm to determine an input to prediction model 112. Additional details regarding such search algorithms will be discussed further below with respect to FIG. 8. As discussed below with respect to FIGS. 7A and 7B below, synthesizer 122 provides respective calls to prediction model 122 for time frames corresponding to respective ranges of time series datasets.

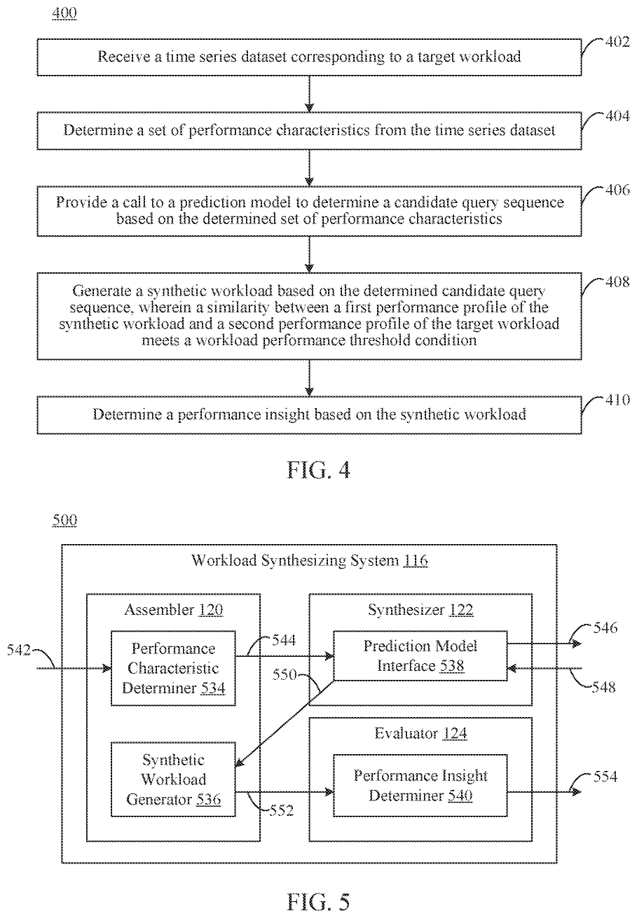

Evaluator 124 evaluates synthetic workloads generated by assembler 120. For example, evaluator 124 evaluates a synthetic workload to perform a database benchmarking operation, perform a workload replay operation, perform a database analytics operation, determine a performance insight, and/or otherwise perform an operation based on the evaluation of the synthetic workload for analytic and/or diagnostic purposes with respect to a database. As shown in FIG. 1, evaluator 124 is a component of workload synthesizing system 116, however, in accordance with one or more alternative embodiments, evaluator 124 is external to workload synthesizing system 116. For example, evaluator 124 may be another service executed by server 102N separate from workload synthesizing system 116, a service executed by another server of system 100, or a service or application executed by another device of system 100. For instance, in accordance with an embodiment, evaluator 124 is a subcomponent of developer application 118N. Additional details regarding the determination of performance insights and evaluation of synthetic workloads will be discussed further below with respect to FIGS. 4 and 5.

Database systems and/or systems that manage database systems may utilize synthetic workloads to perform database benchmarking operations, workload replay operations, and/or any other operations associated with database analytics.

As described above, embodiments described herein utilize a prediction model to determine candidate queries (and/or candidate query sequences) for generating synthetic workloads. The prediction model is a model trained to predict performance characteristics for a workload profile. The prediction model may be trained in various ways, in embodiments. For example, FIG. 2 shows a flowchart 200 of a process for training a prediction model to determine performance profiles in accordance with an example embodiment. Workload profile generator 110 and prediction model 112 of FIG. 1 may operate according to flowchart 200, in embodiments. Not all steps of flowchart 200 need be performed in all embodiments. For illustrative purposes, flowchart 200 is described below with respect to FIG. 3. FIG. 3 shows a block diagram of an example system 300 (“system 300” hereinafter) for training a prediction model in accordance with an example embodiment. System 300 includes workload profile generator 110, prediction model 112, benchmark data 126, configuration data 128, and training data 130, as described above with respect to FIG. 1. Further structural and operational embodiments will be apparent to persons skilled in the relevant art(s) based on the following descriptions of FIGS. 2 and 3.

Flowchart 200 begins with step 202. In step 202, a plurality of benchmark queries and a plurality of hardware configurations are received. For example, as shown in FIG. 3, workload profile generator 110 receives a plurality of benchmark queries 302 (“benchmark queries 302” hereinafter) stored in benchmark data 126 and a plurality of hardware configurations 304 (“hardware configurations 304” hereinafter) stored in configuration data 128. For instance, workload profile generator 110 may obtain benchmark queries 302 and hardware configurations 304 from a data store (e.g., data store 106 of FIG. 1). In accordance with an embodiment, workload profile generator 110 also receives (e.g., obtains) a plurality of software configurations (“software configurations” hereinafter) not shown in FIG. 3. The software configurations may be stored in configuration data 128 or in another set of configuration data, not shown in FIG. 3.

In step 204, a plurality of workload profiles is generated by executing benchmark queries of the plurality of benchmark queries using respective hardware configurations of the plurality of hardware configurations. For example, as shown in FIG. 3, workload profile generator 110 generates a plurality of workload profiles 306 (“workload profiles 306” hereinafter) by executing benchmark queries of benchmark queries 302 using respective hardware configurations of hardware configurations 304. Workload profile generator 110 executes each benchmark query of benchmark queries 302 using each respective hardware configuration of hardware configurations 304 (and/or respective software configurations).

In accordance with one or more embodiments, workload profile generator 110 generates workload profiles based on benchmark queries of benchmark queries 302 with performance that is impacted based on query frequency and/or query concurrency. In this context, “query frequency” is the number of queries a computing device associated with a user (e.g., a client computing device associated with a client) submitted per unit of time (e.g., seconds, minutes, hours, days, etc.), and may be the upper limit of the number of queries submitted per unit of time. “Query concurrency” is the number of active computing devices associated with respective users (e.g., active client computing devices associated with respective clients) submitting queries continuously.

Workload profile generator 110 groups benchmark queries of benchmark queries 302 into “benchmark workloads.” In accordance with an embodiment, a joint enumeration and/or random sampling technique is used to group benchmark queries of benchmark queries 302 into benchmark workloads. Frequency and concurrency of benchmark workloads may be varied. Each benchmark workload may be executed for a period of time (e.g., 5 minutes) using various hardware and/or software configurations. Servers in a cloud computing service network (e.g., servers 102A-102N) may be used to execute the benchmark workload. Each possible combination of benchmark queries of benchmark queries 302 and hardware and/or software configurations may be executed. In accordance with another embodiment, a subset of the possible combinations of benchmark queries of benchmark queries 302 and hardware and/or software configurations is executed. Performance data is collected (e.g., logged) for each executed benchmark workload (i.e., as workload profiles 306).

The collected performance data is stored as training data for training prediction model 112. For example, as shown in FIG. 3, workload profile generator 110 stores workload profiles 306 (and optionally corresponding benchmark queries and hardware configurations) as training data 130 (e.g., in a data store, such as data store 106 of FIG. 1). By collecting and storing training data in this way, workload profile generator 110 builds an extensive library of workload profiles for training prediction model 112. Furthermore, in accordance with one or more embodiments, training data 130 includes training data obtained in addition to workload profiles 306. For example, additional training data is generated by an additional workload profile generator, not shown in FIG. 1. Additional training data may be obtained from user input (e.g., via user application 118A or via developer application 118N). In accordance with another embodiment, additional training data is obtained via a source external to system 100 (e.g., from a database of workload profiles over network 108 or from a computing device not shown in FIG. 1 over network 108).

In step 206, a prediction model is trained to predict performance profiles based on the generated plurality of workload profiles. For example, as shown in FIG. 3, prediction model 112 receives training data 308, which is a subset of or the entirety of training data 130. Training data 308 includes one or more workload profiles of workload profiles 306. Training data 308 indicates respective benchmark queries executed to generate a corresponding workload profile of workload profiles 306. Training data 308 may also indicate hardware and/or software configurations the respective benchmark queries were executed on to generate the corresponding workload profile. By training prediction model 112 in this way, prediction model 112 is enabled to predict performance characteristics of a workload based on the workload and the hardware and/or software configuration used to execute the workload.

The prediction model 112 is trained to predict performance characteristics in various ways. For instance, prediction model 112 is trained to determine performance characteristics based on a workload and a hardware and/or software configuration. In accordance with another embodiment, prediction model 112 is trained to determine performance characteristics based on one or more of a type of a workload, a hardware and/or software configuration, a query frequency of the workload, a query concurrency of the workload, and a product of the query frequency and the query concurrency of the workload.

Thus, training prediction model 112 has been described above with respect to flowchart 200 of FIG. 2 and system 300 of FIG. 3. In accordance with one or more embodiments, training data 130 is (e.g., routinely) updated. For instance, updates to benchmark data 126 and/or configuration data 128 in accordance with an embodiment prompts workload profile generator 110 to generate additional workload profiles based on the updated data and/or combinations of updated data and previous data. In accordance with another embodiment, training data 130 is updated to include workload profiles of synthesized workloads (i.e., synthetic workloads generated by workload synthesizing system 116).

As described above, embodiments described herein enable synthesis of workloads. For example, FIG. 4 shows a flowchart 400 of a process for learned synthesis of workloads in accordance with an example embodiment. Workload synthesis system 116 of FIG. 1 may operate according to flowchart 400, in embodiments. Not all steps of flowchart 400 need be performed in all embodiments. For illustrative purposes, flowchart 400 is described with respect to FIG. 5. FIG. 5 shows a block diagram of workload synthesizing system 114 of FIG. 1, according to an example embodiment. As shown in FIG. 5, workload synthesizing system 116 includes assembler 120, synthesizer 122, and evaluator 124, as described above with respect to FIG. 1. Furthermore, assembler 120 includes a performance characteristic determiner 534 and a synthetic workload generator 536, synthesizer 122 includes a prediction model interface 538, and evaluator 124 includes a performance insight determiner 540. Further structural and operational embodiments will be apparent to persons skilled in the relevant art(s) based on the following descriptions of FIGS. 4 and 5.

Flowchart 400 begins with step 402. In step 402, a time series dataset corresponding to a target workload is received. For example, performance characteristic determiner 534 of FIG. 5 receives time series dataset 542 corresponding to a target workload. Time series dataset 542 is indicative of a workload profile for the execution of the target workload. In other words, time series dataset 542 includes configuration data and performance data with respect to the computing device (or devices) executing the target workload. Time series dataset 542 is received by assembler 120 (or a component thereof) obtaining a workload log (e.g., workload logs 132 of FIG. 1) stored in a data store. In accordance with an embodiment, time series dataset 542 is provided to assembler 120 (e.g., by the computing device that executed the target workload, or by a system that monitors the execution of the target workload to generate time series dataset 542).

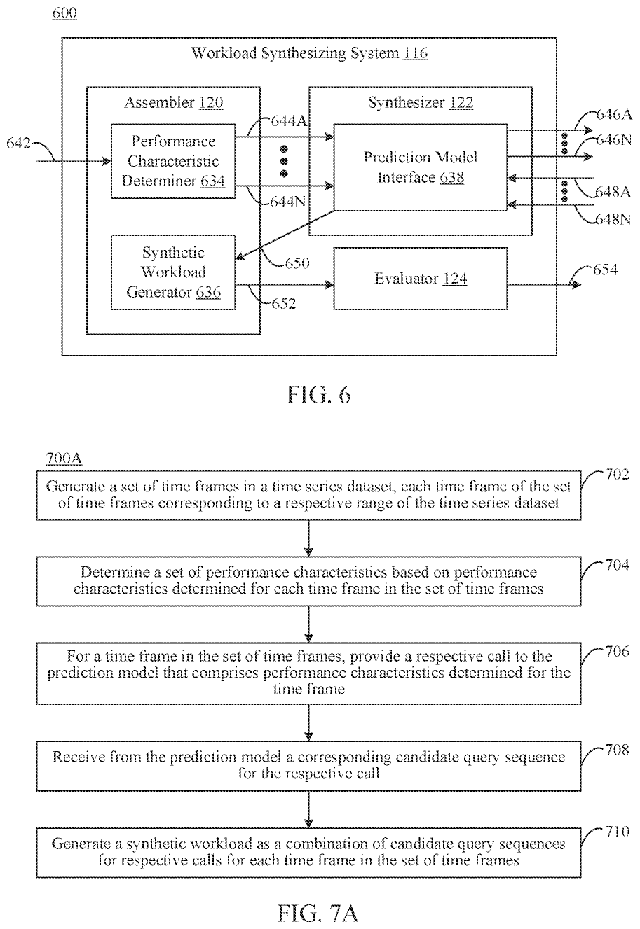

In step 404, a set of performance characteristics is determined from the time series dataset. For example, performance characteristic determiner 534 determines set of performance characteristics 544 from time series dataset 542. Performance characteristic 534 analyzes time series dataset 542 to determine set of performance characteristics 544. For example, suppose time series dataset 542 indicates 20 gigabytes of memory are used in the execution of the target workload. In this context, performance characteristic 534 determines a memory usage performance characteristic of 20 gigabytes. Performance characteristic determiner 534 performs similar analysis of time series dataset 542 to determine other performance characteristics (e.g., CPU core usage, IOPS, latency, execution time, etc.) corresponding to the execution of the target workload. As discussed below with respect to FIGS. 6 and 7A, performance characteristic determiner 534 in accordance with an embodiment determines characteristics for a range of time series dataset 542.

In step 406, a call is provided to a prediction model to determine a candidate query sequence based on the determined set of performance characteristics. For example, prediction model interface 538 provides call 546 to prediction model 112 of FIG. 1 to determine a candidate query sequence based on set of performance characteristics 544. Call 546 includes or otherwise indicates set of performance characteristics 544 and may include respective weights for each performance characteristic of set of performance characteristics 544.

As shown in FIG. 5, prediction model interface 538 receives a response 548 from prediction model 112. Response 548 includes the determined candidate query sequence. In accordance with an embodiment, response 548 includes the query frequency and query concurrency for the candidate query sequence. In accordance with one or more embodiments, response 548 includes multiple candidate query sequences. For instance, response 548 in accordance with an embodiment includes multiple candidate query sequences determined by providing call 546 to prediction model 112 based on set of performance characteristics 544. As discussed further below with respect to FIG. 7B, response 548 in accordance with an embodiment includes multiple candidate query sequences (and optionally respective query frequencies and/or query concurrencies for each candidate query sequence) and a ranking of similarities.

In accordance with one or more embodiments, step 406 includes multiple interactions with prediction model 112 of FIG. 1. For example, prediction model interface 538 provides call 546 to prediction model 112 to identify workload types have performance characteristics similar to set of performance characteristics 544. Prediction model interface 538 (or another component of synthesizer 122, not shown in FIG. 5) utilizes a search algorithm to determine an input to provide prediction model 112. Additional details regarding using search algorithms will be discussed further below with respect to FIG. 8.

In accordance with an embodiment, call 546 provided to prediction model 112 includes an indication of hardware and/or software configurations used to execute the target workload. Alternatively, prediction model 112 includes multiple prediction models that predict performance characteristics for workloads executed by a particular hardware and/or software configuration or subset of hardware and/or software configurations. In this context, prediction model interface 538 determines which prediction model of prediction model 112 to provide call 546 based on the hardware and/or software configuration used to execute the target workload.

In step 408, a synthetic workload is generated based on the determined candidate query sequence. A similarity between a first performance profile of the synthetic workload and a second performance profile of the target workload meets a workload performance threshold condition. For example, synthetic workload generator 536 receives response 550, which includes the candidate query sequence (or query sequences) determined in step 406. Synthetic workload generator 536 generates synthetic workload 552 from the determined candidate query sequence. For instance, synthetic workload generator 536 in accordance with an embodiment combines multiple candidate query sequences into synthetic workload 552. A similarity between a performance profile of synthetic workload 552 and a performance profile of the target workload meets a workload performance threshold condition.

A workload performance threshold condition includes one or more criteria for determining whether or not two performance profiles are similar. For example, when performance characteristics of the target workload and synthetic workload 552 are compared, a mean absolute percentage error (MAPE) is calculated. In accordance with an embodiment, a workload performance threshold condition is met if the MAPEs for a predetermined number of performance characteristics are within respective acceptable ranges. The acceptable range for performance characteristics may be the same or different ranges. For example, a greater margin of error is acceptable for memory usage than CPU cores used.

In accordance with an embodiment, synthetic workload generator 536 (or another component of workload synthesizing system 116, or a component of system 100 of FIG. 1 on behalf of workload synthesizing system 116) (e.g., optionally) executes synthetic workload 552 to validate the synthetic workload. Validating the synthetic workload includes generating a second time series dataset corresponding to the execution of synthetic workload 552. Performance characteristics determined from the second time series dataset are compared with set of performance characteristics 544. If a similarity between the performance characteristics meets a workload performance threshold condition, synthetic workload 552 is validated. Otherwise, synthetic workload generator 536 invalidates synthetic workload 552. If synthetic workload 552 is invalidated, synthetic workload generator 552 generates an updated synthetic workload from a different candidate query sequence determined by prediction model 112, prediction model interface 538 provides a call to prediction model 112 to determine a new candidate query sequence, and/or workload synthesizing system 116 transmits a message to developer application 118N of FIG. 1 that indicates synthetic workload 552 was not validated, as well as any other information associated with the target workload, the determined candidate query sequence, and/or synthetic workload 552.

In accordance with an embodiment, assembler determines a warm-up effect corresponding to a database warming up to execute the target workload. In this context, assembler applies the warm-up effect to the performance profile of synthetic workload 552 in a manner that replicates the effect of the database warming up to execute synthetic workload 552.

In step 410, a performance insight is determined based on the synthetic workload. For example, performance insight determiner 540 determines a performance insight based on synthetic workload 552. Examples of a performance insight include, but are not limited to, a recommended modification to the synthetic workload, a recommended modification to a database service, a comparison of a performance of the synthetic workload and a performance of a modified version of the synthetic workload, a degradation or failure in a database service, a degradation or failure in the execution of the synthetic workload, and/or any other information, indication, insight or prediction that may be determined with respect to a database service and/or the synthetic workload based at least on the synthetic workload. As shown in FIG. 5, performance insight determiner 540 generates a message 554 in response to determining a performance insight based on synthetic workload 552. Message 554 includes one or more determined performance insights, information associated with the synthetic workload (e.g., synthetic workload 552, candidate queries (and/or candidate query sequences) determined by prediction model 112, hardware and/or software configurations for executing synthetic workload 552, etc.), information associated with the target workload (e.g., time series dataset 542, set of performance characteristics 544, etc.), and/or any other information evaluated by or determined by performance insight determiner 540. Performance insight determiner 540 provides message 554 to a computing device associated with a developer (e.g., computing device 104N of FIG. 1) for further evaluation and/or implementation of a determined performance insight. In accordance with another embodiment, performance insight determiner 540 provides message 554 to a database system for automatic implementation of a modification to the database system (e.g., to optimize execution of workloads, to remedy a degradation or failure in the database system, to remedy a degradation or failure in a database service, etc.).

As discussed above, assembler 120 and synthesizer 122 operate in a manner for generating a synthetic workload from a time series dataset by leveraging prediction model 112 to determine a candidate query sequence. In accordance with one or more embodiments, prediction model 112 multiple candidate query sequences are determined. For example, FIG. 6 shows a block diagram of workload synthesizing system 116 of FIG. 1, according to an example embodiment. As shown in FIG. 6, workload synthesizing system 116 includes assembler 120, synthesizer 122, and evaluator 124, as described above with respect to FIG. 1. As also shown in FIG. 6, assembler 120 includes a performance characteristic determiner 634 and synthetic workload generator 636 and synthesizer 122 includes a prediction model interface 638. Performance characteristic determiner 634, synthetic workload generator 636, and prediction model interface 638 operate in similar respective manners as performance characteristic determiner 534, synthetic workload generator 536, and prediction model interface 538, as described above with respect to FIG. 5, with the following differences.

For illustrative purposes, workload synthesizing system 116 of FIG. 6 is described below with respect to FIG. 7A. FIG. 7A shows a flowchart 700A of a process for learned synthesis of workloads in accordance with an example embodiment. Workload synthesizing system 116 of FIG. 6 may operate according to flowchart 700A in embodiments. Not all steps of flowchart 700A need be performed in all embodiments. Further structural and operational embodiments will be apparent to persons skilled in the relevant art(s) based on the following descriptions of FIGS. 6 and 7A.

Flowchart 700A begins with step 702. In accordance with an embodiment, step 702 is a subset of step 404 of flowchart 400, as described above with respect to FIG. 4. In step 702, a set of time frames is generated in a time series dataset. Each time frame of the set of time frames corresponds to a respective range of the time series dataset. For example, performance characteristic determiner 634 of FIG. 6 receives time series dataset 642 and generates a set of time frames in time series dataset 642, each time frame corresponding to a respective range of time series dataset 642. In accordance with an embodiment, the set of time frames are a representative subset of time series dataset 642. In accordance with another embodiment, the set of time frames represent the entirety of time series dataset 642. The respective range of each time frame may be equal, or one or more time frames has a different sized range from another time frame in the set of time frames.

Flowchart 700A continues to step 704, which in accordance with an embodiment is a subset of step 404 of flowchart 400, as described above with respect to FIG. 4. In step 704, a set of performance characteristics is determined based on performance characteristics determined for each time frame in the set of time frames. For example, performance characteristic determiner 634 of FIG. 6 determines respective performance characteristics 644A-644N (“set of performance characteristics 644” hereinafter) for each time frame in the set of time frames generated in step 702. In accordance with an embodiment, set of performance characteristics 644 include configuration information that indicates hardware and/or software configurations used to execute the target workload. As shown in FIG. 7A, set of performance characteristics 644 is provided to prediction model interface 638 of synthesizer 122, and flowchart 700A continues to step 706.

In accordance with an embodiment step 706 is a subset of step 406 of flowchart 400, as described above with respect to FIG. 4. In step 706, for a time frame in the set of time frames, a respective call is provided to the prediction model. The respective call includes performance characteristics determined for the time frame. For example, prediction model interface 638 of FIG. 6 provides respective call 646A to prediction model 112 of FIG. 1, respective call 646A includes performance characteristics 644A determined for the time frame corresponding to respective call 646A. In accordance with an embodiment, respective call 646A includes configuration information that indicates hardware and/or software configurations used to execute the respective portion of the target workload.

In step 708, for the respective call, a corresponding candidate query sequence is received from the prediction model. A respective second similarity between a respective third performance profile of the corresponding candidate query sequence and a respective fourth performance profile of the time frame corresponding to the respective call meets a query performance threshold condition. For example, prediction model interface 638 of FIG. 6 receives, for respective call 646A, a corresponding response 648A from prediction model 112 of FIG. 1. Corresponding response 648A includes a corresponding candidate query sequence (or multiple corresponding candidate query sequences). In accordance with an embodiment, corresponding response 648A includes a query frequency and/or query concurrency for the corresponding candidate query sequence. A respective similarity between a performance profile of the corresponding candidate query sequence (or candidate query sequences) and a respective performance profile of the time frame corresponding to respective call 646A meets a query performance threshold condition. The performance profile of the corresponding candidate query sequence (or candidate query sequences) includes performance characteristics corresponding to an execution of the corresponding candidate query sequence (or candidate query sequences) using the hardware and/or software configurations included in respective call 646A (e.g., a hardware and/or software configuration similar to or the same as the hardware and/or software configuration used to execute the target workload). In this context, a query performance threshold condition is met if the performance profile of the corresponding candidate query sequence is similar to the performance profile of the time frame corresponding to respective call 646A.

A query performance threshold condition includes one or more criteria for determining whether or not performance profiles of a candidate query sequence (or candidate query sequences) and a time frame are similar. In accordance with an embodiment, a query performance threshold condition includes criteria similar to workload performance threshold conditions, as described above with respect to FIGS. 4 and 5. For example, performance characteristics of the time frame are compared to performance characteristics of the candidate query sequence. In this context, a margin of error between the performance characteristics of the time frame and the candidate query sequence is within an acceptable range. A query performance threshold condition may include a condition for determining the candidate query sequence (or candidate query sequences) with the lowest margin of error between performance characteristics of the candidate query sequence and the time frame.

In accordance with one or more embodiments, steps 706 and 708 are repeated for each time frame in the set of time frames generated in step 702. For example, prediction model interface 638 of FIG. 6 provides respective calls 646A-646N to prediction model 112 of FIG. 1 and receives respective responses 648A-648N from prediction model 112, each respective response 648A-648N including a respective candidate query sequence (or query sequences). Prediction model interface 638 may sequentially provide respective calls 646A-646N to prediction model 112 or provide respective calls 646A-646N simultaneously to prediction model 112. In accordance with an embodiment, prediction model interface 638 provides a subset of respective calls 646A-646N to prediction model 112. For example, prediction model interface 638 may provide respective calls to prediction model 112 that correspond to time frames where resource usage is above a predetermined usage threshold (e.g., non-zero resource usage, resource usage of at least a predetermined amount greater than zero, etc.).

Flowchart 700A ends with step 710, which in accordance with an embodiment is a subset of step 408 of flowchart 400, as described with respect to FIG. 4. In step 710, a synthetic workload is generated as a combination of candidate query sequences for respective calls for each time frame in the set of time frames. For example, synthetic workload generator 636 of FIG. 6 generates a synthetic workload 652 as a combination of the respective candidate query sequences received in responses 648A-648N. For instance, as shown in FIG. 6, synthetic workload generator 636 receives a response 650 from prediction model interface 634. Response 650 in accordance with an embodiment includes the respective candidate query sequences received in responses 648A-648N. Synthetic workload generator 636 in accordance with an embodiment reconstructs the candidate query sequences into synthetic workload 652 in a manner that a similarity between a performance profile of synthetic workload 652 and a performance profile of the target workload corresponding to time series dataset 642 meets a workload performance threshold condition, as described elsewhere herein.

In accordance with an embodiment, synthetic workload generator 636 replays (e.g., executes) one or more candidate query sequences, one or more queries of the candidate query sequences, and/or synthetic workload 652. For example, synthetic workload 636 (e.g., sequentially) replays queries of synthetic workload 652 to generate a workload profile that is similar to time series dataset 642. Alternatively, synthetic workload generator 636 (e.g., sequentially) replays queries of a subset of the candidate query sequences that were used to generate synthetic workload 652 to generate the workload profile. The subset of the candidate query sequences includes queries of candidate query sequence that correspond to time frames where resource usage is above a predetermined usage threshold (e.g., non-zero resource usage, resource usage of at least a predetermined amount greater than zero, etc.). By determining the subset of candidate query sequences to replay, synthetic workload generator 636 generates synthetic workload 652 in a manner that improves evaluation thereof by evaluator 124. For example, by reducing the number of candidate query sequences for evaluator 124 to evaluate, evaluator 124 is enabled to determine performance insights while using less compute resources. While synthetic workload generator 636 has been described as replaying one or more candidate query sequences, one or more queries of the candidate query sequences, and/or synthetic workload 652, alternatively, another component of workload synthesizing system 116 (e.g., evaluator 124) or another component of system 100 of FIG. 1 (e.g., developer application 118N) may be configured to replay queries, sequences, and/or workloads in a similar manner.

In accordance with one or more embodiments, evaluator 124 predicts a performance insight and generates a message 654 based on synthetic workload 652, in a similar manner as described above with respect to FIGS. 4 and 5.

Workload synthesizing system 116 of FIG. 6 has been described above with respect to respective calls to a prediction model for each time frame in a set of time frames and receiving from the prediction model a set of candidate query sequences that include, for each respective call, a corresponding candidate query sequence. In accordance with one or more alternative embodiments, the prediction model determines multiple candidate query sequences for a respective call. For example, FIG. 7B shows a flowchart 700B of a process for providing a call to a prediction model to determine a candidate query sequence in accordance with an example embodiment. Workload synthesizing system 116 of FIG. 6 may operate according to flowchart 700B in embodiments. Not all steps of flowchart 700B need be performed in all embodiments. Further structural and operational embodiments will be apparent to persons skilled in the relevant art(s) based on the following descriptions of FIGS. 6 and 7B.

Flowchart 700B begins with step 712. As shown in FIG. 7B, step 712 is preceded by steps 702 and 704 of flowchart 700A, in embodiments. In accordance with an embodiment, step 712 is a subset of step 406 of flowchart 400, as described above in reference to FIG. 4. In step 712, for a time frame in the set of time frames, a respective call is provided to the prediction model. The respective call comprises performance characteristics determined for the time frame. For example, prediction model interface 638 of FIG. 6 provides respective call 646A to prediction model 112 of FIG. 1, respective call 646A includes performance characteristics 644A determined for the time frame corresponding to respective call 646A. Respective call 646A includes configuration information that indicates hardware and/or software configurations used to execute the respective portion of the target workload.

In step 714, for the respective call, a plurality of candidate query sequences and a ranking of similarities are received from the prediction model. A respective second similarity between a respective third performance profile of a corresponding one of the plurality of candidate query sequences and a fourth performance profile of the time frame corresponding to the respective call meets a query performance threshold condition. The ranking of similarities indicates ranks of each of the respective second similarities with respect to each other. For example, prediction model interface 638 of FIG. 6 receives, for respective call 646A, a corresponding response 648A from prediction model 112 of FIG. 1. Corresponding response 648A includes a plurality of candidate query sequences and a ranking of similarities. A respective similarity between respective performance profiles of the plurality of candidate query sequences and a performance profile of the time frame corresponding to respective call 646A meets a query performance threshold condition. In other words, each candidate query sequence of the plurality of candidate query sequences has a performance profile similar to a performance profile of the time frame corresponding to respective call 646A.

As discussed above, in step 714, prediction model interface 638 receives a ranking of similarities from prediction model 112. The ranking of similarities indicates ranks of each of the respective similarities between a respective performance profile of a candidate query sequence of the plurality of candidate query sequences and the performance profile of the time frame corresponding to respective call 646A. For instance, the rankings in accordance with an embodiment indicates which candidate query sequence of the plurality of candidate query sequences has a performance profile that is most similar to the performance profile of the time frame.

In accordance with an embodiment, prediction model interface 638 uses a search algorithm to determine via prediction model 112 the plurality of candidate query sequences and ranking of similarities. For example, prediction model interface 638 uses Bayesian optimization over 100 iterations and receives response 648A including three candidate query sequences with the highest ranked similarities with respect to other searched queries. Additional details in regard to using search algorithms will be discussed further below with respect to FIG. 8.

In accordance with an embodiment, steps 712 and 714 of flowchart 700B are repeated for each respective call of respective calls 646A-646N. In this context, respective responses 648A-648N are received. Synthetic workloads are generated from candidate query sequences included in respective responses 648A-648N, as described elsewhere herein. In accordance with an embodiment, steps 712 and 714 are repeated for a subset of respective calls 646A-646N, as described above with respect to FIG. 7A.

As discussed above, prediction model in accordance with one or more alternative embodiments determines multiple candidate query sequences for a respective call. Furthermore, workload synthesizing system 116 of FIG. 6 generates synthetic workloads based on the respective multiple candidate query sequences for each respective call, in embodiments. For example, FIG. 7C shows a flowchart 700C of a process for generating a synthetic workload in accordance with an example embodiment. Workload synthesizing system 116 of FIG. 6 may operate according to flowchart 700C in embodiments. Not all steps of flowchart 700C need be performed in all embodiments. Further structural and operational embodiments will be apparent to persons skilled in the relevant art(s) based on the following descriptions of FIGS. 6 and 7C.

As shown in FIG. 7C, flowchart 700C in accordance with an embodiment is preceded by steps 712 and 714 of flowchart 700B, as described above with respect to FIG. 7B. For instance, steps 712-714 of flowchart 700B in accordance with an embodiment are repeated for each time frame in the set of time frames. For example, for each time frame, a respective call is provided to the prediction model, as described above with respect to step 712. For each respective call, a respective plurality of candidate query sequences and a respective ranking of similarities are received from the prediction model. Flowchart 700C is described further below with respect to the forgoing context

Flowchart 700C begins with step 716, which in accordance with an embodiment is a subset of step 408 of flowchart 400, as described above with respect to FIG. 4. In step 716, for each respective call, a candidate query sequence is selected from a respective plurality of candidate query sequences. For example, synthetic workload generator 636 receives response 650 from prediction model interface 638. Response 650 includes a respective plurality of candidate query sequences for each respective call 646A-646N provided to prediction model 112, as described above with respect to flowchart 700B of FIG. 7B. Synthetic workload generator 636 selects at least one candidate query sequence from a respective plurality of candidate query sequences for each respective call 646A-646N. In this context, the selected candidate query sequences correspond to the ranges of time series dataset 642 that the time frames generated by performance characteristics determiner 634 correspond to. In embodiments, synthetic workload generator 636 selects the candidate query sequence with the highest rank for each respective call 646A-646N, and/or a candidate query sequence is selected based on a prior selected candidate query sequence. For example, synthetic workload generator 636 determines which candidate query sequence to select for a subsequent time frame based at least on the candidate query sequence selected for the preceding time frame.

Flowchart 700C continues to step 718, which in accordance with an embodiment is a subset of step 408 of flowchart 400, as described above with respect to FIG. 4. In step 718, a synthetic workload is generated as a combination of the selected candidate query sequences. For example, synthetic workload generator 636 generates synthetic workload 652 as a combination of the candidate query sequences selected in step 716.

In accordance with an embodiment, multiple synthetic workloads are generated. For instance, synthetic workload generator 636 generates a number of “candidate” synthetic workloads, wherein a respective similarity between a performance profile of a candidate synthetic workload and the performance profile of the target workload meets a workload performance threshold condition. In this context, synthetic workload generator 636 generates a set of workload rankings. The set of workload rankings indicates ranking of the similarities with respect to each other. For instance, synthetic workload generator 636 in accordance with an embodiment generates three candidate synthetic workloads. By generating multiple synthetic workloads, evaluator 124 is enabled to determine performance insights from multiple synthetic workloads. Furthermore, multiple synthetic workloads that potentially match the target workload are considered, thereby enabling evaluator 124, or a developer utilizing developer application 118N, to perform database benchmarking, workload replay, and/or other database analytic operations with respect to the synthetic workloads.

As discussed above, embodiments described herein may implement a search algorithm to determine an input to prediction model 112. FIG. 8 shows a flowchart 800 of a process for providing a call to a prediction model in accordance with an example embodiment. Synthesizer 122 of FIG. 1 operates according to flowchart 800 in embodiments. Not all steps of flowchart 800 need be performed in all embodiments. Further structural and operational embodiments will be apparent to persons skilled in the relevant art(s) based on the following descriptions of FIG. 8.

Flowchart 800 begins with step 802. In step 802, an input to a prediction model is determined by utilizing a search algorithm. For example, synthesizer 122 of FIG. 1 determines an input to prediction model 112 by utilizing a search algorithm. Example search algorithms include, but are not limited to, Bayesian optimization, gradient descent, and graduated optimization. For instance, synthesizer 122 of FIG. 1 (or a component thereof) utilizes a search algorithm to determine query frequency and query concurrency settings for one or more candidate query sequences. In accordance with an embodiment, synthesizer 122 determines the query frequency and query concurrency settings by minimizing the mean squared percentage error (MSPE) between an estimated workload profile and the workload profile of the target workload.

Flowchart 800 continues to step 804, which in accordance with an embodiment is a subset of step 406 of flowchart 400, as described above with respect to FIG. 4. In step 804, the determined input is provided to the prediction model. For example, prediction model interface 538 of FIG. 5 provides the determined input to prediction model 112. The determined input is provided along with the call to the prediction model, as described above with respect to step 406 of FIG. 4. In accordance with another embodiment, the determined input is provided in a subsequent call to the prediction model (e.g., after identifying workload types).

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

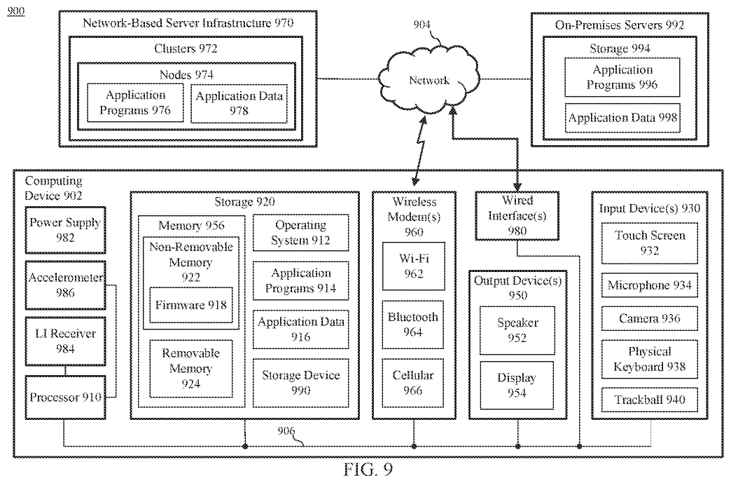

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 9. FIG. 9 shows a block diagram of an exemplary computing environment 900 that includes a computing device 902. Computing device 902 is an example of server 102A, server 102B, server 102C, server 102N, computing device 104A, and/or computing device 104N, of FIG. 1, each of which may include one or more of the components of computing device 902. In some embodiments, computing device 902 is communicatively coupled with devices (not shown in FIG. 9) external to computing environment 900 via network 904. Network 904 is an example of network 108 of FIG. 1. Network 904 comprises one or more networks such as local area networks (LANs), wide area networks (WANs), enterprise networks, the Internet, etc., and may include one or more wired and/or wireless portions. Network 904 may additionally or alternatively include a cellular network for cellular communications. Computing device 902 is described in detail as follows.

Computing device 902 can be any of a variety of types of computing devices. For example, computing device 902 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 902 may alternatively be a stationary computing device such as a desktop computer, a personal computer (PC), a stationary server device, a minicomputer, a mainframe, a supercomputer, etc.

As shown in FIG. 9, computing device 902 includes a variety of hardware and software components, including a processor 910, a storage 920, one or more input devices 930, one or more output devices 950, one or more wireless modems 960, one or more wired interfaces 980, a power supply 982, a location information (LI) receiver 984, and an accelerometer 986. Storage 920 includes memory 956, which includes non-removable memory 922 and removable memory 924, and a storage device 990. Storage 920 also stores an operating system 912, application programs 914, and application data 916. Wireless modem(s) 960 include a Wi-Fi modem 962, a Bluetooth modem 964, and a cellular modem 966. Output device(s) 950 includes a speaker 952 and a display 954. Input device(s) 930 includes a touch screen 932, a microphone 934, a camera 936, a physical keyboard 938, and a trackball 940. Not all components of computing device 902 shown in FIG. 9 are present in all embodiments, additional components not shown may be present, and any combination of the components may be present in a particular embodiment. These components of computing device 902 are described as follows.

A single processor 910 (e.g., central processing unit (CPU), microcontroller, a microprocessor, signal processor, ASIC (application specific integrated circuit), and/or other physical hardware processor circuit) or multiple processors 910 may be present in computing device 902 for performing such tasks as program execution, signal coding, data processing, input/output processing, power control, and/or other functions. Processor 910 may be a single-core or multi-core processor, and each processor core may be single-threaded or multithreaded (to provide multiple threads of execution concurrently). Processor 910 is configured to execute program code stored in a computer readable medium, such as program code of operating system 912 and application programs 914 stored in storage 920. Operating system 912 controls the allocation and usage of the components of computing device 902 and provides support for one or more application programs 914 (also referred to as “applications” or “apps”). Application programs 914 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 902 can communicate with any other component according to function, although not all connections are shown for ease of illustration. For instance, as shown in FIG. 9, bus 906 is a multiple signal line communication medium (e.g., conductive traces in silicon, metal traces along a motherboard, wires, etc.) that may be present to communicatively couple processor 910 to various other components of computing device 902, although in other embodiments, an alternative bus, further buses, and/or one or more individual signal lines may be present to communicatively couple components. Bus 906 represents one or more of any of several types of bus structures, including a memory bus or memory controller, a peripheral bus, an accelerated graphics port, and a processor or local bus using any of a variety of bus architectures.

Storage 920 is physical storage that includes one or both of memory 956 and storage device 990, which store operating system 912, application programs 914, and application data 916 according to any distribution. Non-removable memory 922 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 922 may include main memory and may be separate from or fabricated in a same integrated circuit as processor 910. As shown in FIG. 9, non-removable memory 922 stores firmware 918, which may be present to provide low-level control of hardware. Examples of firmware 918 include BIOS (Basic Input/Output System, such as on personal computers) and boot firmware (e.g., on smart phones). Removable memory 924 may be inserted into a receptacle of or otherwise coupled to computing device 902 and can be removed by a user from computing device 902. Removable memory 924 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 990 may be present that are internal and/or external to a housing of computing device 902 and may or may not be removable. Examples of storage device 990 include a hard disk drive, a SSD, a thumb drive (e.g., a USB (Universal Serial Bus) flash drive), or other physical storage device.

One or more programs may be stored in storage 920. Such programs include operating system 912, one or more application programs 914, and other program modules and program data. Examples of such application programs may include, for example, computer program logic (e.g., computer program code/instructions) for implementing one or more of workload profile generator 110, prediction model 112, resource(s) 114, workload synthesizing system 116, user application 118A, developer application 118N, assembler 120, synthesizer 122, evaluator 124, performance characteristic determiner 534, synthetic workload generator 536, prediction model interface 538, performance insight determiner 540, performance characteristic determiner 634, synthetic workload generator 636, prediction model interface 638, along with any components and/or subcomponents thereof, as well as the flowcharts/flow diagrams (e.g., methods 200, 400, 700A, 700B, 700C, and/or 800) described herein, including portions thereof, and/or further examples described herein.

Storage 920 also stores data used and/or generated by operating system 912 and application programs 914 as application data 916. Examples of application data 916 include web pages, text, images, tables, sound files, video data, and other data, which may also be sent to and/or received from one or more network servers or other devices via one or more wired or wireless networks. Storage 920 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 902 through one or more input devices 930 and may receive information from computing device 902 through one or more output devices 950. Input device(s) 930 may include one or more of touch screen 932, microphone 934, camera 936, physical keyboard 938 and/or trackball 940 and output device(s) 950 may include one or more of speaker 952 and display 954. Each of input device(s) 930 and output device(s) 950 may be integral to computing device 902 (e.g., built into a housing of computing device 902) or external to computing device 902 (e.g., communicatively coupled wired or wirelessly to computing device 902 via wired interface(s) 980 and/or wireless modem(s) 960). Further input devices 930 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 954 may display information, as well as operating as touch screen 932 by receiving user commands and/or other information (e.g., by touch, finger gestures, virtual keyboard, etc.) as a user interface. Any number of each type of input device(s) 930 and output device(s) 950 may be present, including multiple microphones 934, multiple cameras 936, multiple speakers 952, and/or multiple displays 954.

One or more wireless modems 960 can be coupled to antenna(s) (not shown) of computing device 902 and can support two-way communications between processor 910 and devices external to computing device 902 through network 904, as would be understood to persons skilled in the relevant art(s). Wireless modem 960 is shown generically and can include a cellular modem 966 for communicating with one or more cellular networks, such as a GSM network for data and voice communications within a single cellular network, between cellular networks, or between the mobile device and a public switched telephone network (PSTN). Wireless modem 960 may also or alternatively include other radio-based modem types, such as a Bluetooth modem 964 (also referred to as a “Bluetooth device”) and/or Wi-Fi 962 modem (also referred to as an “wireless adaptor”). Wi-Fi modem 962 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 964 is configured to communicate with another Bluetooth-capable device according to the Bluetooth short-range wireless technology standard(s) such as IEEE 802.15.1 and/or managed by the Bluetooth Special Interest Group (SIG).

Computing device 902 can further include power supply 982, LI receiver 984, accelerometer 986, and/or one or more wired interfaces 980. Example wired interfaces 980 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 980 of computing device 902 provide for wired connections between computing device 902 and network 904, or between computing device 902 and one or more devices/peripherals when such devices/peripherals are external to computing device 902 (e.g., a pointing device, display 954, speaker 952, camera 936, physical keyboard 938, etc.). Power supply 982 is configured to supply power to each of the components of computing device 902 and may receive power from a battery internal to computing device 902, and/or from a power cord plugged into a power port of computing device 902 (e.g., a USB port, an A/C power port). LI receiver 984 may be used for location determination of computing device 902 and may include a satellite navigation receiver such as a Global Positioning System (GPS) receiver or may include other type of location determiner configured to determine location of computing device 902 based on received information (e.g., using cell tower triangulation, etc.). Accelerometer 986 may be present to determine an orientation of computing device 902.

Note that the illustrated components of computing device 902 are not required or all-inclusive, and fewer or greater numbers of components may be present as would be recognized by one skilled in the art. For example, computing device 902 may also include one or more of a gyroscope, barometer, proximity sensor, ambient light sensor, digital compass, etc. Processor 910 and memory 956 may be co-located in a same semiconductor device package, such as being included together in an integrated circuit chip, FPGA, or system-on-chip (SOC), optionally along with further components of computing device 902.

In embodiments, computing device 902 is configured to implement any of the above-described features of flowcharts herein. Computer program logic for performing any of the operations, steps, and/or functions described herein may be stored in storage 920 and executed by processor 910.

In some embodiments, server infrastructure 970 may be present in computing environment 900 and may be communicatively coupled with computing device 902 via network 904. Server infrastructure 970, when present, may be a network-accessible server set (e.g., a cloud-based environment or platform). As shown in FIG. 9, server infrastructure 970 includes clusters 972. Each of clusters 972 may comprise a group of one or more compute nodes and/or a group of one or more storage nodes. For example, as shown in FIG. 9, cluster 972 includes nodes 974. Each of nodes 974 are accessible via network 904 (e.g., in a “cloud-based” embodiment) to build, deploy, and manage applications and services. Any of nodes 974 may be a storage node that comprises a plurality of physical storage disks, SSDs, and/or other physical storage devices that are accessible via network 904 and are configured to store data associated with the applications and services managed by nodes 974. For example, as shown in FIG. 9, nodes 974 may store application data 978.

Each of nodes 974 may, as a compute node, comprise one or more server computers, server systems, and/or computing devices. For instance, a node 974 may include one or more of the components of computing device 902 disclosed herein. Each of nodes 974 may be configured to execute one or more software applications (or “applications”) and/or services and/or manage hardware resources (e.g., processors, memory, etc.), which may be utilized by users (e.g., customers) of the network-accessible server set. For example, as shown in FIG. 9, nodes 974 may operate application programs 976. In an implementation, a node of nodes 974 may operate or comprise one or more virtual machines, with each virtual machine emulating a system architecture (e.g., an operating system), in an isolated manner, upon which applications such as application programs 976 may be executed.

In an embodiment, one or more of clusters 972 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 972 may be a datacenter in a distributed collection of datacenters. In embodiments, exemplary computing environment 900 comprises part of a cloud-based platform such as Amazon Web Services® of Amazon Web Services, Inc. or Google Cloud Platform™ of Google LLC, although these are only examples and are not intended to be limiting.

In an embodiment, computing device 902 may access application programs 976 for execution in any manner, such as by a client application and/or a browser at computing device 902. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 902 may additionally and/or alternatively synchronize copies of application programs 914 and/or application data 916 to be stored at network-based server infrastructure 970 as application programs 976 and/or application data 978. For instance, operating system 912 and/or application programs 914 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 920 at network-based server infrastructure 970.

In some embodiments, on-premises servers 992 may be present in computing environment 900 and may be communicatively coupled with computing device 902 via network 904. On-premises servers 992, when present, are hosted within an organization's infrastructure and, in many cases, physically onsite of a facility of that organization. On-premises servers 992 are controlled, administered, and maintained by IT (Information Technology) personnel of the organization or an IT partner to the organization. Application data 998 may be shared by on-premises servers 992 between computing devices of the organization, including computing device 902 (when part of an organization) through a local network of the organization, and/or through further networks accessible to the organization (including the Internet). Furthermore, on-premises servers 992 may serve applications such as application programs 996 to the computing devices of the organization, including computing device 902. Accordingly, on-premises servers 992 may include storage 994 (which includes one or more physical storage devices such as storage disks and/or SSDs) for storage of application programs 996 and application data 998 and may include one or more processors for execution of application programs 996. Still further, computing device 902 may be configured to synchronize copies of application programs 914 and/or application data 916 for backup storage at on-premises servers 992 as application programs 996 and/or application data 998.

Embodiments described herein may be implemented in one or more of computing device 902, network-based server infrastructure 970, and on-premises servers 992. For example, in some embodiments, computing device 902 may be used to implement systems, clients, or devices, or components/subcomponents thereof, disclosed elsewhere herein. In other embodiments, a combination of computing device 902, network-based server infrastructure 970, and/or on-premises servers 992 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 920. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 914) may be stored in storage 920. Such computer programs may also be received via wired interface(s) 980 and/or wireless modem(s) 960 over network 904. Such computer programs, when executed or loaded by an application, enable computing device 902 to implement features of embodiments discussed herein. Accordingly, such computer programs represent controllers of the computing device 902.

Embodiments are also directed to computer program products comprising computer code or instructions stored on any computer-readable medium or computer-readable storage medium. Such computer program products include the physical storage of storage 920 as well as further physical storage types.

### IV. Additional Example Embodiments

A system is described herein. The system includes a processor circuit and a memory. The memory stores program code that, when executed by the processor circuit, performs operations. The operations comprise: receiving a time series dataset corresponding to a target workload; determining a set of performance characteristics from the time series dataset; providing a call to a prediction model to determine a candidate query sequence based on the determined set of performance characteristics; generating a synthetic workload based on the determined candidate query sequence, wherein a first similarity between a first performance profile of the synthetic workload and a second performance profile of the target workload meets a workload performance threshold condition; and determining a performance insight based on the synthetic workload.

In one implementation of the foregoing system, said determining a set of performance characteristics from the time series dataset comprises: generating a set of time frames in the time series dataset, each time frame of the set of time frames corresponding to a respective range of the time series dataset; and determining the set of performance characteristics based on performance characteristics determined for each time frame in the set of time frames.

In one implementation of the foregoing system, said providing the call to the prediction model comprises providing, for a time frame in the set of time frames, a respective call to the prediction model that comprises performance characteristics determined for the time frame. The operations further comprise receiving from the prediction model a corresponding candidate query sequence for the respective call, wherein a respective second similarity between a respective third performance profile of the corresponding candidate query sequence and a respective fourth performance profile of the time frame corresponding to the respective call meets a query performance threshold condition.

In one implementation of the foregoing system, said generating the synthetic workload based on the candidate query sequence comprises generating the synthetic workload as a combination of corresponding candidate query sequences for respective calls for each time frame in the set of time frames.

In one implementation of the foregoing system, said providing the call to the prediction model comprises providing, for a time frame in the set of time frames, a respective call to the prediction model that comprises performance characteristics determined for the time frame. The operations further comprise receiving from the prediction model, for the respective call, a plurality of candidate query sequences and a ranking of similarities, wherein a respective second similarity between a respective third performance profile of a corresponding one of the plurality of candidate query sequences and a fourth performance profile of the time frame corresponding to the respective call meets a query performance threshold condition, and wherein ranking of similarities indicates ranks of each of the respective second similarities with respect to each other.

In one implementation of the foregoing system, the prediction model is trained by: receiving a plurality of benchmark queries and a plurality of hardware configurations; generating a plurality of workload profiles by executing benchmark queries of the plurality of benchmark queries using respective hardware configurations of the plurality of hardware configurations; and training the prediction model to predict performance profiles based on the generated plurality of workload profiles.

In one implementation of the foregoing system, the operations further comprise determining an input to the prediction model by utilizing a search algorithm. Said providing the call to the prediction model to determine the candidate query sequence based on the determined set of performance characteristics comprises providing the determined input to the prediction model.

In one implementation of the foregoing system, the time series dataset does not include which queries were included in a prior execution of the target workload.

In one implementation of the foregoing system, said determining the performance insight based on the synthetic workload comprises determining a recommended modification to the synthetic workload.

In one implementation of the foregoing system, said determining the performance insight based on the synthetic workload comprises determining a recommended modification to a database service.

In one implementation of the foregoing system, said determining the performance insight based on the synthetic workload comprises comparing a performance of the synthetic workload and a performance of a modified version of the synthetic workload.

In one implementation of the foregoing system, said determining the performance insight based on the synthetic workload comprises determining a degradation in a database service.

In one implementation of the foregoing system, said determining the performance insight based on the synthetic workload comprises determining a failure in a database service.

In one implementation of the foregoing system, said determining the performance insight based on the synthetic workload comprises determining a degradation in the execution of the synthetic workload.

In one implementation of the foregoing system, said determining the performance insight based on the synthetic workload comprises determining a failure in the execution of the synthetic workload.

A computer-implemented method is described herein. The computer-implemented method comprises: receiving a time series dataset corresponding to a target workload; determining a set of performance characteristics from the time series dataset; providing a call to a prediction model to determine a candidate query sequence based on the determined set of performance characteristics; generating a synthetic workload based on the determined candidate query sequence, wherein a similarity between a first performance profile of the synthetic workload and a second performance profile of the target workload meets a workload performance threshold condition; and determining a performance insight based on the synthetic workload.

In one implementation of the foregoing computer-implemented method, said determining the performance insight based on the synthetic workload comprises: determining a recommended modification to the synthetic workload; determining a recommended modification to a database service; comparing a performance of the synthetic workload and a performance of a modified version of the synthetic workload; determining a degradation or failure in a database service; or determining a degradation or a failure in the execution of the synthetic workload.

In one implementation of the foregoing computer-implemented method, said determining a set of performance characteristics from the time series dataset comprises: generating a set of time frames in the time series dataset, each time frame of the set of time frames corresponding to a respective range of the time series dataset; and determining the set of performance characteristics based on performance characteristics determined for each time frame in the set of time frames.

In one implementation of the foregoing computer-implemented method, said providing the call to the prediction model comprises providing, for a time frame in the set of time frames, a respective call to the prediction model that comprises performance characteristics determined for the time frame. The computer-implemented method further comprises receiving from the prediction model a corresponding candidate query sequence for the respective call, wherein a respective second similarity between a respective third performance profile of the corresponding candidate query sequence and a respective fourth performance profile of the time frame corresponding to the respective call meets a query performance threshold condition.

In one implementation of the foregoing computer-implemented method, said generating the synthetic workload based on the candidate query sequence comprises generating the synthetic workload as a combination of the corresponding candidate query sequences for respective calls for each time frame in the set of time frames.

In one implementation of the foregoing computer-implemented method, said providing the call to the prediction model comprises providing, for a time frame in the set of time frames, a respective call to the prediction model that comprises performance characteristics determined for the time frame. The computer-implemented method further comprises receiving from the prediction model, for the respective call, a plurality of candidate query sequences and a ranking of similarities, wherein a respective second similarity between a respective third performance profile of a corresponding one of the plurality of candidate query sequences and a fourth performance profile of the time frame corresponding to the respective call meets a query performance threshold condition, and wherein ranking of similarities indicates ranks of each of the respective second similarities with respect to each other.

In one implementation of the foregoing computer-implemented method, the prediction model is trained by: receiving a plurality of benchmark queries and a plurality of hardware configurations; generating a plurality of workload profiles by executing benchmark queries of the plurality of benchmark queries using respective hardware configurations of the plurality of hardware configurations; and training the prediction model to predict performance profiles based on the generated plurality of workload profiles.

In one implementation of the foregoing computer-implemented method, the computer-implemented method further comprises determining an input to the prediction model by utilizing a search algorithm. Said providing the call to the prediction model to determine the candidate query sequence based on the determined set of performance characteristics comprises providing the determined input to the prediction model.

In one implementation of the foregoing computer-implemented method, the time series dataset does not include which queries were included in a prior execution of the target workload.

A computer-readable storage medium is described herein. The computer-readable storage medium has computer program logic recorded thereon that when executed by a processor circuit causes the processor circuit to perform a method. The method comprises: receiving a time series dataset corresponding to a target workload; determining a set of performance characteristics from the time series dataset; providing a call to a prediction model to determine a candidate query sequence based on the determined set of performance characteristics; generating a synthetic workload based on the determined candidate query sequence, wherein a similarity between a first performance profile of the synthetic workload and a second performance profile of the target workload meets a workload performance threshold condition; and determining a performance insight based on the synthetic workload.

In one implementation of the foregoing computer-readable storage medium, said determining the performance insight based on the synthetic workload comprises determining a recommended modification to the synthetic workload.

In one implementation of the foregoing computer-readable storage medium, said determining the performance insight based on the synthetic workload comprises determining a recommended modification to a database service.

In one implementation of the foregoing computer-readable storage medium, said determining the performance insight based on the synthetic workload comprises comparing a performance of the synthetic workload and a performance of a modified version of the synthetic workload.

In one implementation of the foregoing computer-readable storage medium, said determining the performance insight based on the synthetic workload comprises determining a degradation in a database service.

In one implementation of the foregoing computer-readable storage medium, said determining the performance insight based on the synthetic workload comprises determining a failure in a database service.

In one implementation of the foregoing computer-readable storage medium, said determining the performance insight based on the synthetic workload comprises determining a degradation in the execution of the synthetic workload.

In one implementation of the foregoing computer-readable storage medium, said determining the performance insight based on the synthetic workload comprises determining a failure in the execution of the synthetic workload.

In one implementation of the foregoing computer-readable storage medium, said determining a set of performance characteristics from the time series dataset comprises: generating a set of time frames in the time series dataset, each time frame of the set of time frames corresponding to a respective range of the time series dataset; and determining the set of performance characteristics based on performance characteristics determined for each time frame in the set of time frames.

In one implementation of the foregoing computer-readable storage medium, said providing the call to the prediction model comprises providing, for a time frame in the set of time frames, a respective call to the prediction model that comprises performance characteristics determined for the time frame. The method further comprises receiving from the prediction model a corresponding candidate query sequence for the respective call, wherein a respective second similarity between a respective third performance profile of the corresponding candidate query sequence and a respective fourth performance profile of the time frame corresponding to the respective call meets a query performance threshold condition.

In one implementation of the foregoing computer-readable storage medium, said generating the synthetic workload based on the candidate query sequence comprises generating the synthetic workload as a combination of the corresponding candidate query sequences for respective calls for each time frame in the set of time frames.

In one implementation of the foregoing computer-readable storage medium, said providing the call to the prediction model comprises providing, for a time frame in the set of time frames, a respective call to the prediction model that comprises performance characteristics determined for the time frame. The method further comprises receiving from the prediction model, for the respective call, a plurality of candidate query sequences and a ranking of similarities, wherein a respective second similarity between a respective third performance profile of a corresponding one of the plurality of candidate query sequences and a fourth performance profile of the time frame corresponding to the respective call meets a query performance threshold condition, and wherein ranking of similarities indicates ranks of each of the respective second similarities with respect to each other.

In one implementation of the foregoing computer-readable storage medium, the prediction model is trained by: receiving a plurality of benchmark queries and a plurality of hardware configurations; generating a plurality of workload profiles by executing benchmark queries of the plurality of benchmark queries using respective hardware configurations of the plurality of hardware configurations; and training the prediction model to predict performance profiles based on the generated plurality of workload profiles.

In one implementation of the foregoing computer-readable storage medium, the method further comprises determining an input to the prediction model by utilizing a search algorithm. Said providing the call to the prediction model to determine the candidate query sequence based on the determined set of performance characteristics comprises providing the determined input to the prediction model.

In one implementation of the foregoing computer-readable storage medium, the time series dataset does not include which queries were included in a prior execution of the target workload.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, services, identity systems, target services, resources, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A system, comprising:
a processor circuit; and
a memory that stores program code that, when executed by the processor circuit, performs operations, the operations comprising:
receiving a time series dataset corresponding to a target workload;
determining a set of performance characteristics from the time series dataset, the set of performance characteristics corresponding to execution of the target workload;
providing a call to a prediction model to determine a candidate query sequence based on the determined set of performance characteristics;
generating a synthetic workload based on the determined candidate query sequence, wherein a first similarity between a first performance profile of the synthetic workload and a second performance profile of the target workload meets a workload performance threshold condition; and
determining a performance insight based on the synthetic workload.

2. The system of claim 1, wherein said determining a set of performance characteristics from the time series dataset comprises:
generating a set of time frames in the time series dataset, each time frame of the set of time frames corresponding to a respective range of the time series dataset; and
determining the set of performance characteristics based on performance characteristics determined for each time frame in the set of time frames.

3. The system of claim 2, wherein:
said providing the call to the prediction model comprises:
providing, for a time frame in the set of time frames, a respective call to the prediction model that comprises performance characteristics determined for the time frame; and
the operations further comprise:
receiving from the prediction model a corresponding candidate query sequence for the respective call, wherein a respective second similarity between a respective third performance profile of the corresponding candidate query sequence and a respective fourth performance profile of the time frame corresponding to the respective call meets a query performance threshold condition.

4. The system of claim 3, wherein said generating the synthetic workload based on the candidate query sequence comprises:
generating the synthetic workload as a combination of corresponding candidate query sequences for respective calls for each time frame in the set of time frames.

5. The system of claim 2, wherein:
said providing the call to the prediction model comprises:
providing, for a time frame in the set of time frames, a respective call to the prediction model that comprises performance characteristics determined for the time frame; and
the operations further comprise:
receiving from the prediction model, for the respective call, a plurality of candidate query sequences and a ranking of similarities, wherein a respective second similarity between a respective third performance profile of a corresponding one of the plurality of candidate query sequences and a fourth performance profile of the time frame corresponding to the respective call meets a query performance threshold condition, and wherein ranking of similarities indicates ranks of each of the respective second similarities with respect to each other.

6. The system of claim 1, wherein the prediction model is trained by:
receiving a plurality of benchmark queries and a plurality of hardware configurations;
generating a plurality of workload profiles by executing benchmark queries of the plurality of benchmark queries using respective hardware configurations of the plurality of hardware configurations; and
training the prediction model to predict performance profiles based on the generated plurality of workload profiles.

7. The system of claim 1, wherein:
the operations further comprise:
determining an input to the prediction model by utilizing a search algorithm; and
said providing the call to the prediction model to determine the candidate query sequence based on the determined set of performance characteristics comprises providing the determined input to the prediction model.

8. The system of claim 1, wherein the time series dataset does not include which queries were included in a prior execution of the target workload.

9. A computer-implemented method, comprising:
receiving a time series dataset corresponding to a target workload;
determining a set of performance characteristics from the time series dataset;
providing a call to a prediction model to determine a candidate query sequence based on the determined set of performance characteristics, the set of performance characteristics corresponding to execution of the target workload;
generating a synthetic workload based on the determined candidate query sequence, wherein a similarity between a first performance profile of the synthetic workload and a second performance profile of the target workload meets a workload performance threshold condition; and
determining a performance insight based on the synthetic workload.

10. The computer-implemented method of claim 9, wherein said determining the performance insight based on the synthetic workload comprises:
determining a recommended modification to the synthetic workload;
determining a recommended modification to a database service;
comparing a performance of the synthetic workload and a performance of a modified version of the synthetic workload;
determining a degradation or failure in a database service; or
determining a degradation or a failure in the execution of the synthetic workload.

11. The computer-implemented method of claim 9, wherein said determining a set of performance characteristics from the time series dataset comprises:
generating a set of time frames in the time series dataset, each time frame of the set of time frames corresponding to a respective range of the time series dataset; and
determining the set of performance characteristics based on performance characteristics determined for each time frame in the set of time frames.

12. The computer-implemented method of claim 11, wherein:
said providing the call to the prediction model comprises:
providing, for a time frame in the set of time frames, a respective call to the prediction model that comprises performance characteristics determined for the time frame; and
the computer-implemented method further comprises:
receiving from the prediction model a corresponding candidate query sequence for the respective call, wherein a respective second similarity between a respective third performance profile of the corresponding candidate query sequence and a respective fourth performance profile of the time frame corresponding to the respective call meets a query performance threshold condition.

13. The computer-implemented method of claim 12, wherein said generating the synthetic workload based on the candidate query sequence comprises:
generating the synthetic workload as a combination of the corresponding candidate query sequences for respective calls for each time frame in the set of time frames.

14. The computer-implemented method of claim 11, wherein:
said providing the call to the prediction model comprises:
providing, for a time frame in the set of time frames, a respective call to the prediction model that comprises performance characteristics determined for the time frame; and
the computer-implemented method further comprises:
receiving from the prediction model, for the respective call, a plurality of candidate query sequences and a ranking of similarities, wherein a respective second similarity between a respective third performance profile of a corresponding one of the plurality of candidate query sequences and a fourth performance profile of the time frame corresponding to the respective call meets a query performance threshold condition, and wherein ranking of similarities indicates ranks of each of the respective second similarities with respect to each other.

15. The computer-implemented method of claim 9, wherein the prediction model is trained by:
receiving a plurality of benchmark queries and a plurality of hardware configurations;
generating a plurality of workload profiles by executing benchmark queries of the plurality of benchmark queries using respective hardware configurations of the plurality of hardware configurations; and
training the prediction model to predict performance profiles based on the generated plurality of workload profiles.

16. The computer-implemented method of claim 9, wherein:
the computer-implemented method further comprises:
determining an input to the prediction model by utilizing a search algorithm; and
said providing the call to the prediction model to determine the candidate query sequence based on the determined set of performance characteristics comprises providing the determined input to the prediction model.

17. The computer-implemented method of claim 9, wherein the time series dataset does not include which queries were included in a prior execution of the target workload.

18. A computer-readable storage medium having computer program logic recorded thereon that when executed by a processor circuit causes the processor circuit to perform a method comprising:
receiving a time series dataset corresponding to a target workload;
determining a set of performance characteristics from the time series dataset;
providing a call to a prediction model to determine a candidate query sequence based on the determined set of performance characteristics, the set of performance characteristics corresponding to execution of the target workload;
generating a synthetic workload based on the determined candidate query sequence, wherein a similarity between a first performance profile of the synthetic workload and a second performance profile of the target workload meets a workload performance threshold condition; and
determining a performance insight based on the synthetic workload.

19. The computer-readable storage medium of claim 18, wherein:
the method further comprises:
determining an input to the prediction model by utilizing a search algorithm; and
said providing the call to the prediction model to determine the candidate query sequence based on the determined set of performance characteristics comprises providing the determined input to the prediction model.

20. The computer-readable storage medium of claim 18, wherein the time series dataset does not include which queries were included in a prior execution of the target workload.
